(19) United States
(12) Patent Application Publication
(10) Pub. No.: US 2005/0185133 A1
(43) Pub. Date: Aug. 25, 2005

(54) Diffraction grating wave plate

(76) Inventors: Paul Winer, Santa Clara, CA (US); Dmitri E. Nikonov, San Jose, CA (US)

Correspondence Address: TROP PRUNER & HU, PC, 8554 KATY FREEWAY, SUITE 100, HOUSTON, TX, 77024, US

(21) Appl. No.: 10/787,553

(22) Filed: Feb. 24, 2004

(51) Int. Cl. G02F 1/13

(52) U.S. Cl. 349/201

(57) ABSTRACT

A compensator for a display may include a diffraction grating formed by making grooves in the surface of a glass plate. In some embodiments, the diffraction grating acting as a wave plate may be separate from the light engine and in other embodiments, it may be integrated into the cover glass of the light engine.

### BACKGROUND

This invention relates generally to polarization optical devices.

A wave plate (also known as a retarder) is an optical device which selectively affects polarizations of light and thereby can change the state of polarization of the incident light beam.

A wave plate may be utilized to increase contrast in display devices. For example, in liquid crystal over semiconductor micro-display projection display systems, a wave plate is utilized to rotate the polarization of the outgoing light to increase contrast. Generally, a wave plate made out of a birefringent material is utilized. The birefringent wave plate must be applied as a separate, relatively expensive element, increasing the manufacturing cost.

Thus, there is a need for better ways of compensating optical devices such as displays.

### BRIEF DESCRIPTION OF THE DRAWINGS

FIG. 1 is a schematic depiction of one embodiment of the present invention;

FIG. 2 is a schematic depiction of a display in accordance with one embodiment of the present invention; and

FIG. 3 is a schematic depiction of a display in accordance with one embodiment of the present invention.

### DETAILED DESCRIPTION

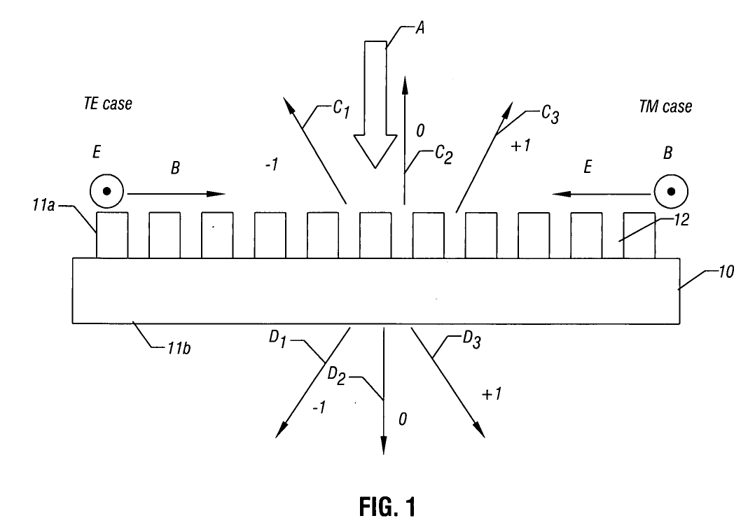

Referring to FIG. 1, a diffraction grating 10 may have a plurality of parallel grooves 12 formed in its upwardly facing surface. In one embodiment, the diffraction grating 10 is the cover plate of a display such as a liquid crystal over semiconductor micro-display.

The liquid crystal over semiconductor micro-display is based on polarization rotation of incident linearly polarized light in a reflective liquid crystal cell. The polarization rotation is varied by application of an electric field. The brightness of a selected pixel is set by directing the light through another polarization optic called an analyzer. To achieve desirable contrast, additional polarization rotation is applied in the form of static rotation compensation. To this end, a compensator, retarder, or wave plate is utilized. Conventionally, such compensators are made using birefringent material which is relatively expensive.

In one embodiment, the depth of the grooves 12 in the grating 10 can be controlled by depositing a layer 11a of glass of defined thickness having a different etch rate than the substrate 11b. The grooves may be made by lithographic definition and subsequent reactive ion etching of the deposited glass layer.

The surface of the grating 10 causes the incident light wave front A to break up and diffract at angles other than the incident angle. Light propagates through the grating 10 differently depending on its polarization. In the case of TE polarization, the electric field E is parallel to the grooves and the magnetic field B is across the grooves as indicated in FIG. 1. In the case of TM polarization, the magnetic field B is along the grooves while the electric field E is across the grooves, also as indicated in FIG. 1. The two polarizations reflect differently at all air-glass interfaces. That makes the effective number of bounces of diffracted light in the grooves 12 different for the two polarizations.

The phase accumulated via transmission through the grating 10 is different for the TE and TM polarizations. As a result, the grating 10 rotates polarization. For example, if the grating 10 is such that the difference of phases between the TE and TM polarizations is π/2 radians, light linearly polarized at 45 degrees to the grooves 12 is turned into circularly polarized light after one pass through the grating 10. In other words, the grating 10 acts as a wave plate.

In some embodiments of the present invention, the phase difference changes relatively little over a range of groove depths. The transmitted intensity may be a substantial portion of the incident intensity in some embodiments. The phase difference may change little over the wavelength range of interest in some embodiments.

In FIG. 1, the reflected light is indicated as C1, C2, and C3 for the −1, 0, and +1 diffraction orders. The transmitted light is indicated as D1, D2, and D3 for the −1, 0, and +1 diffraction orders. The number of diffraction orders can be more or less depending on the geometry of the grating.

In one embodiment of the present invention, the diffraction grating 10 may be made of glass having a groove width of 0.35 microns and a groove depth of 0.8 microns. The glass may have an index of 1.5 in that embodiment. However, other configurations are also contemplated.

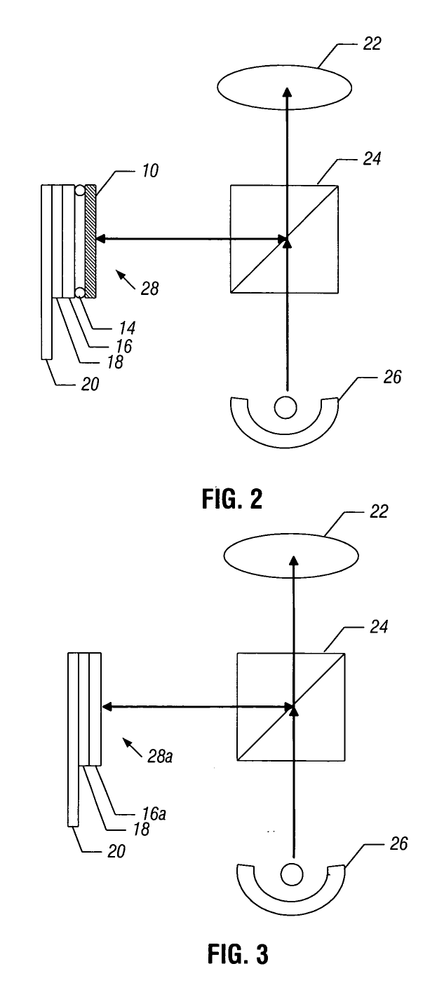

Referring to FIG. 2, a display may include the diffraction grating 10 in accordance with one embodiment of the present invention. The display may include a light source 26 and a polarizing beam splitter (PBS) 24. The output light is projected through projection optics 22. The polarizer sends part of the light beam through the diffraction grating 10. The grating 10 forms part of a light engine 28. The diffraction grating 10 may be secured to the rest of the light engine 28 by an adhesive 14 in one embodiment. A cover glass 16 may cover a liquid crystal over semiconductor micro-display 18 in one embodiment of the present invention. The micro-display 18 may include a package 20.

In an alternate embodiment of the present invention, the diffraction grating 10 may be integrated into the cover glass 16a as shown in FIG. 3. By forming the compensator as part of the cover glass 16a, one assembly step may be eliminated in some embodiments of the present invention.

An example has been given in the present specification where linearly polarized light underwent a phase change of 90 degrees. Such a device is commonly called a quarter wave plate. However, wave plates with different phase changes may also be utilized in accordance with other embodiments of the present invention. For example, a linear polarization may be changed into an elliptical polarization with varying degrees of ellipticity. As used herein, a change of polarization state includes converting linear to circular, linear to elliptical, and vice versa.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A wave plate comprising:
a substrate having a periodic surface structure formed therein.

2. The wave plate of claim 1 wherein the substrate is transparent.

3. The wave plate of claim 1 wherein the periodic surface structure includes a plurality of parallel grooves formed therein.

4. The wave plate of claim 1, wherein said grooves are arranged to convert linearly polarized light into circularly polarized light.

5. The wave plate of claim 1, wherein said substrate is formed of two layers, said grooves extending through one of said layers down to the other said layers.

6. The wave plate of claim 1, wherein light propagates through the wave plate depending on its polarization.

7. The wave plate of claim 1, wherein light propagates after reflection in said wave plate depending on its polarization.

8. The wave plate of claim 1, wherein the light transmitted through the wave plate has a different phase depending on its polarization.

9. The wave plate of claim 1, wherein said light is turned into circularly polarized light after one pass through the wave plate.

10. An optical system comprising:
a light source;
optics to transmit an output polarized light beam;
a wave plate between said display and said output light beam optics, said plate including a substrate having a plurality of parallel grooves formed therein.

11. The optical system of claim 10 including a polarizing beam splitter coupled to receive light from said light source.

12. The optical system of claim 10 wherein said system is a display.

13. The optical system of claim 10, wherein said grooves are arranged to convert linearly polarized light into circularly polarized light.

14. The optical system of claim 10, wherein said substrate is formed of two layers, said grooves extending through one of said layers down to the other said layers.

15. The optical system of claim 10, wherein light propagates through the wave plate depending on its polarization.

16. The optical system of claim 10, wherein the light transmitted through the wave plate has a different phase depending on its polarization.

17. The optical system of claim 10, wherein said light is turned into circularly polarized light after one pass through the wave plate.

18. The optical system of claim 10 wherein said wave plate is integrated with said display.

19. The optical system of claim 18 wherein said display includes a cover and said wave plate is integral with said cover plate.

20. The optical system of claim 10 wherein said display is a liquid crystal over semiconductor micro-display.

21. A method comprising:
forming a plurality of parallel grooves in a transparent structure to fabricate a wave plate.

22. The method of claim 21 including arranging said grooves to convert linearly polarized light into circularly polarized light.

23. The method of claim 21 including securing said wave plate to a display.

24. The method of claim 21 including forming said wave plate as part of the cover of a display.

25. The method of claim 24 including forming said wave plate as part of the cover of a liquid crystal over semiconductor micro-display.
